(19) United States
(12) Patent Application Publication
(10) Pub. No.: US 2011/0234342 A1
(43) Pub. Date: Sep. 29, 2011

(54) Micro Magnetic Device for Carriers Translocation

(75) Inventors: CheolGi Kim, Daejeon (KR); Sarella Ananda Kumar, Daejeon (KR)

(73) Assignee: The Industry & Academic Cooperation in Chungnam National University (IAC), Daejeon (KR)

(21) Appl. No.: 12/836,265

(22) Filed: Jul. 14, 2010

(30) Foreign Application Priority Data
Mar. 25, 2010 (KR) 10-2010-002665

(51) Int. Cl. H01F 13/00

(52) U.S. Cl. 335/284

(57) ABSTRACT

Disclosed is a magnetic force generator for controlling an external magnetic field to magnetize a micro magnetic device and a microbead; the micro magnetic device for generating an internal magnetic field when magnetized by the external magnetic field, and controlling movement of the microbead according to a direction of magnetization; and the microbead which immobilizes a biomolecule on a surface thereof and of which movement is controlled by the internal magnetic field generated as the micro magnetic device is magnetized.

### CROSS-REFERENCE(S) TO RELATED APPLICATIONS

The present invention claims priority of Korean Patent Application No. 10-2010-002665, filed on Mar. 25, 2010, which is incorporated herein by reference.

### BACKGROUND OF THE INVENTION

1. Field of the Invention

The present invention relates to a micro magnetic device for biomolecule translocation, and more particularly, to a micro magnetic device for biomolecule translocation, in which a micromolecule and a microbead bound by biological reaction changes their flow path in a microfluidic channel by influence of a magnetic force applied from a magnetic force generator.

2. Description of Related Art

It is difficult for existing laboratory systems to promptly process a large amount of bio-information poured as the human genome project has been completed and the post-genomic era has arrived. Accordingly, biological identification systems for investigation of vital phenomena, development of new drug and diagnosis are being developed into the forms of a micro-Total Analysis System (μ-TAS) and a lab-on-a-chip, which are for analyzing a sample accurately and conveniently in a short time with less amount of the sample on the basis of microfluidics.

Since most of biochemical samples to be analyzed are present in the form of a solution, a technique to translocate the liquid sample can be the most important factor. The microfluidics is just the field of microfluidic flow control, and is the field of studying and developing essential technologies that form the foundation of commercialization of the μ-TAS and the lab-on-a-chip.

The μ-TAS is a system that totally carries out chemical and biological experiment and analysis, which go through a plurality of experimental steps and reactions, on a single unit present in a single experimental stand. This μ-TAS includes a sample collection area, a microfluidic circuit, a detector and a controller for controlling them.

Meanwhile, the lab-on-a-chip means a laboratory within a chip or a laboratory on a chip, in which a microfluidic channel of nanoliter or smaller is fabricated using a material such as plastic, glass and silicon and a liquid sample of only several nanoliters is translocated through the microfluidic channel, whereby existing experimental or study procedures can be carried out quickly.

Realization of μ-TAS or a lab-on-a-chip capable of quickly carrying out analysis for sharply increasing bio-information can be effectively achieved when it is combined with proper bioassay methods.

Methods for analyzing biomolecules include immunoassay, DNA hybridization and receptor-based analysis. These detection methods for analyzing biomolecules are widely used not only in analysis in laboratories but also in medical diagnosis and development of new drug.

The immunoassay is an analyzing technology that uses a binding reaction between antigen and antibody and includes various forms according to the test principle, and the DNA hybridization uses a compensatory binding between a probe DNA and a target DNA. Also, the receptor-based analysis is an analyzing technology that uses binding ability between a specific molecule and its receptor. The use of selective binding ability of antibody, DNA, RNA and molecular receptor, which can specifically bind, to a detection molecule enables detection of various biomolecules.

Since the binding procedure of these biomolecules cannot be observed directly, markers capable of generating a detectable signal is used. In general, fluorescent material, radioactive material, enzyme or magnetic particle is used as the marker. In this detection method, it is important to generate a high sensitive signal so as to enable recognition of a trace amount of detection molecule.

In particular, target materials to be analyzed are recently diversified in the fields of development of new drug and diagnosis with development of synthetic chemistry and life science, and these target materials are very high in cost and are not easily obtained. Therefore, there is increasing needs for cost reduction through the trace analysis.

Among detection methods to ensure generation of high sensitive signal, various methods using magnetic particles have been reported. U.S. Pat. No. 5,981,297 discloses a method in which recognition agents selectively immobilizing target molecules are bound to magnetizable particles and a magnetoresistive or magnetostrictive response of these bound particles to a magnetic field sensor is observed to detect the particles.

There has been developed a method of detecting a desired DNA by immobilizing a DNA to a Giant Magnetoresistive (GMR) device and measuring a magnetic flux of a magnetic particle, which is used as a marker, as a value of resistance variation. Also, there is a method, in which in order to find whether magnetic particles are immobilized by a biological recognition procedure, a residual magnetism and a magnetic susceptibility from a magnetic particle of iron oxide (Fe₃O₄) are measured from the magnetic particles using a Superconducting Quantum Interference Device (SQUID) to thereby recognize a detection molecule. The above described methods show high sensitive detection ability in biomolecule detection.

However, the high sensitive detection systems using magnetic nanoparticles are the system that directly measures the magnetic flux of the magnetic field of the magnetic nanoparticles, and have problems that equipments for detecting the magnetic flux is complex, and it is therefore necessarily required to introduce an resultant expensive equipment and it is not able to make the equipments having a small size. There is also a problem that a microchip for GMR measurement goes through very complex processes.

Furthermore, the above described methods have problems that multiple detection and sample preparation procedures are not simplified since they are a planar array type in which receptor molecules are immobilized on a planar substrate to carry out analysis.

Although there exist apparatuses for separating biomolecules based on microbeads, they have limited ability to carry out complex operation since the microbeads are fabricated with a permanent magnet or an electromagnet of 5 mm or greater. Also, current technology for biomolecule translocation is not sufficient to control at nono-scale. Further, systems for bioassay are generally difficult in manufacture and high in cost, and also generate heat that may kill biological individuals. Furthermore, movement of magnetic media using this system is not smoother than the micro magnetic device for biomolecule translocation in accordance with the present invention.

In addition, since conventional magnetic tweezers and microneedles have only one tip, they can translocate only one magnetic medium and cannot translocate media in neighboring group.

### SUMMARY OF THE INVENTION

An embodiment of the present invention is directed to providing a micro magnetic device for biomolecule translocation, in which a micromolecule and a microbead bound by biological reaction changes their flow path in a microfluidic channel by influence of a magnetic force applied from a magnetic force generator, and it is thus possible to control movement of the microbead according to a direction and intensity of the magnetic force.

To achieve the object of the present invention, the present invention provides a micro magnetic device for biomolecule translocation, which includes a magnetic force generator for controlling an external magnetic field to magnetize a micro magnetic device and a microbead; the micro magnetic device for generating an internal magnetic field when magnetized by the external magnetic field, and controlling movement of the microbead according to a direction of magnetization; and the microbead which immobilizes a biomolecule on a surface thereof and of which movement is controlled by the internal magnetic field generated as the micro magnetic device is magnetized.

Preferably, the micro magnetic device is formed by patterning a soft magnetic thin film made of one of NiFe, Fe, Ni and Co.

Preferably, the micro magnetic device has one shape of an elliptic disc and a semi-elliptic disc.

Preferably, the micro magnetic device is arranged in series so as to attract the microbead to a sensing site in which probe molecules are immobilized within a microfluidic chip.

Preferably, the micro magnetic device has a saturation magnetization of 1 tesla and a length of 10 μm or smaller.

Preferably, a degree of change of the internal magnetic field is within a range of 10⁴ T/m.

Preferably, the micro magnetic device magnetized by the external magnetic field generates a partial internal magnetic field by its geometrical structure and soft magnetism, and moves the microbead to a pole of the micro magnetic device where the internal magnetic field is strongest by a difference between magnetic forces of the internal magnetic fields.

Preferably, the micro magnetic device magnetized by the external magnetic field generates a partial internal magnetic field by its geometrical structure and soft magnetism, and moves the microbead by the rotating or oscillating external magnetic field.

Preferably, the microbead is translocated to a specific position of the fluidic channel when the external magnetic field rotates in a clockwise direction or a counterclockwise direction and the micro magnetic device has an elliptic disc shape and is within the fluidic channel.

Preferably, the microbead is translocated forward when the external magnetic field rotates in a clockwise direction and the micro magnetic device has a semi-elliptic disc shape, and the microbead is translocated backward when the external magnetic field rotates in a counterclockwise direction and the micro magnetic device has a semi-elliptic disc shape.

Preferably, when the external magnetic field rotates in a clockwise direction and the micro magnetic devices are arranged in a diagonal direction, the microbeads are concentrated in a portion where the diagonal lines are gathered, and when the external magnetic field rotates in a counterclockwise direction and the micro magnetic devices are arranged in a diagonal direction, the microbeads are spread from the portion where the diagonal lines are gathered.

Preferably, the portion where the diagonal lines are gathered is a sensing site in which probe molecules are immobilized within a microfluidic chip.

The present invention provides an apparatus for controlling translocation and operation of a superparamagnetic microbead using the micro magnetic device and has advantages that it has potential superior to the conventional translocation conductor and is easily fabricated and no heat is generated in a chip, which is an essential factor in the manipulation and translocation of a biological individual.

### BRIEF DESCRIPTION OF THE DRAWINGS

FIG. 1 is a view illustrating movement of microbeads by an external magnetic field when a micro magnetic device for biomolecule translocation in accordance with an embodiment of the present invention has an elliptic disc shape.

FIG. 2 is a view illustrating a structure that micro magnetic devices of an elliptic disc shape for straight linear movement of a microbead are arranged in series.

FIG. 3 is a view illustrating a structure that micro magnetic devices of a semi-elliptic disc shape for forward and backward directional movement of a microbead are arranged in series.

FIGS. 4 and 5 are views illustrating a structure that micro magnetic devices of a semi-elliptic disc shape for gathering or spreading microbeads according to a rotational direction of an external magnetic field are arranged in series in a diagonal direction.

### DETAILED DESCRIPTION OF MAIN ELEMENTS

100: External magnetic field
200: Micro magnetic device
300: Microbead
400: Internal magnetic field
500: Magnetization direction of micro magnetic device

### DESCRIPTION OF SPECIFIC EMBODIMENTS

The advantages, features and aspects of the invention will become apparent from the following description of the embodiments with reference to the accompanying drawings, which is set forth hereinafter.

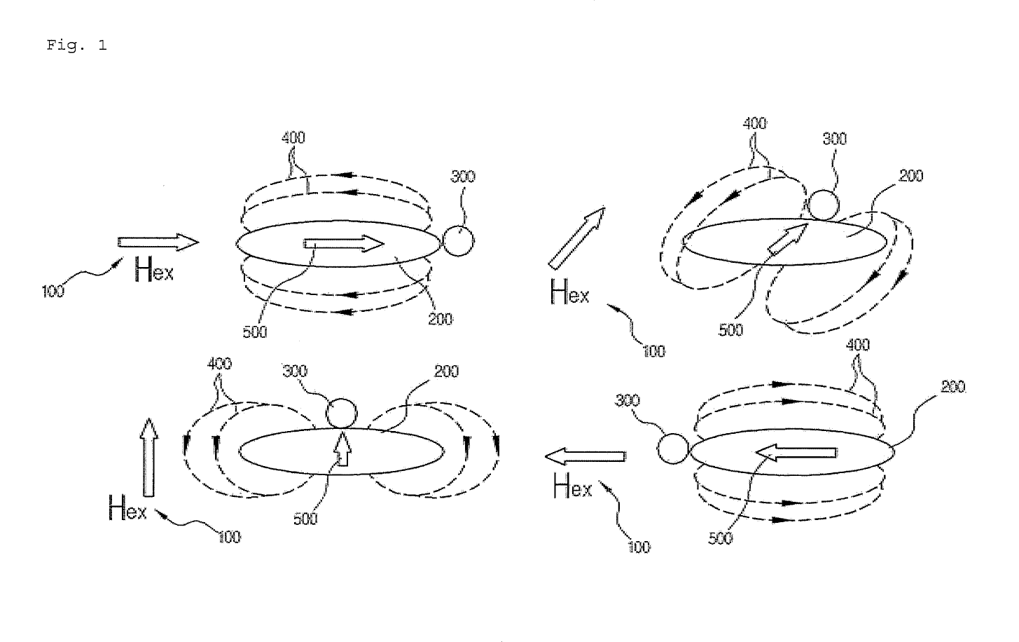

FIG. 1 is a view illustrating movement of microbeads by an external magnetic field when a micro magnetic device for biomolecule translocation in accordance with an embodiment of the present invention has an elliptic disc shape.

As illustrated, a micro magnetic device for biomolecule translocation in accordance with an embodiment of the present invention includes a magnetic force generator (not shown), a micro magnetic device 200 and a microbead 300.

The magnetic force generator in accordance with an embodiment of the present invention may include an array of electrodes placed apart from a microfluidic channel. The magnetic force generator controls an external magnetic field 100 to magnetize the micro magnetic device 200 and the microbead 300. For example, the magnetic generator can change a rotational direction of the external magnetic field 100 into the clockwise direction or a counterclockwise direction.

The magnetic field and the microbead 300 in accordance with an embodiment of the present invention have excellent biocompatibility. In general, this process is non-invasive and does not damage a biological sample immobilized on a surface of the microbead 300. The external magnetic field 100 in accordance with an embodiment of the present invention is sufficient to magnetically saturate the microbead 300.

The microbead 300 in accordance with an embodiment of the present invention consists of a superparamagnetic material. Preferably, the surface of the microbead 300 in accordance with an embodiment of the present invention is subject to surface treatment that allows binding of biomolecules capable of binding with a probe molecule to the surface.

The microbead 300 in accordance with an embodiment of the present invention may be configured such that a receptor or a ligand molecule capable of receiving single or double stranded nucleic acids, nucleic acid analogues, heptanes, proteins, peptides, antibodies or a fragment thereof and sugar structures is immobilized to the surface of the microbead 300 to induce biomolecular reaction.

The biomolecular reaction may consist of various antigen-antibody reaction such as virus antigen and virus antibody, pathogenic microbe and antibody of the pathogenic microbe, and reaction between bioactive substance pair including reactions between biotin and avidin, immunoglobulin G and protein A, hormone and hormone receptor, DNA and DNA receptor, RNA and RNA receptor and drug and drug receptor.

The micro magnetic device 200 in accordance with an embodiment of the present invention generates an internal magnetic field 400 when it is magnetized by the external magnetic field 100 and the movement of the microbead 300 is controlled according to the magnetization direction of the micro magnetic device 200. The micro magnetic device 200 in accordance with an embodiment of the present invention can be formed by patterning a soft magnetic thin film made of one of NiFe, Fe, Ni and Co.

Also, as illustrated, the micro magnetic device in accordance with an embodiment of the present invention may have one shape of a disc, an elliptic disc and a semi-elliptic disc.

The internal magnetic field 400 is generated by the magnetization of the micro magnetic device 200. The magnetization of the micro magnetic device 200 in accordance with an embodiment of the present invention depends on a geometrical structure of the micro magnetic device 200 and the external magnetic field 100 applied to the micro magnetic device 200.

The micro magnetic device 200 in accordance with an embodiment of the present invention has a saturation magnetization of 1 tesla and a length of 10 μm or smaller. Also, a degree of change of the internal magnetic field 400 in accordance with an embodiment of the present invention is within a range of 10⁴ T/m.

The microbead 300 immobilizes a biomolecule on a surface thereof and movement of the microbead 300 is controlled by the internal magnetic field 400 generated as the micro magnetic device 200 is magnetized.

One dimensional movement of the microbead 300 is carried out by magnetic force. The magnetic force can be generated by the magnetization of the microbead 300 and the degree of change of the internal magnetic field 400. The magnetic force is in proportion to the degree of change of the internal magnetic field 400 as expressed by the following mathematical equation 1.

\vec{F}=\vec{∇}(\vec{M}·\vec{B})

where, \vec{F} is magnetic force between the micro magnetic device 200 and the microbead 300, \vec{B} is a magnetic flux density by the micro magnetic device 200, and \vec{M} is a magnetic moment of the microbead 300. Since this magnetic force is generated in proportion to the intensity of the magnetic field and degree of change of the magnetic field, it is possible to determine deviational degree of a path with varying the magnetic field.

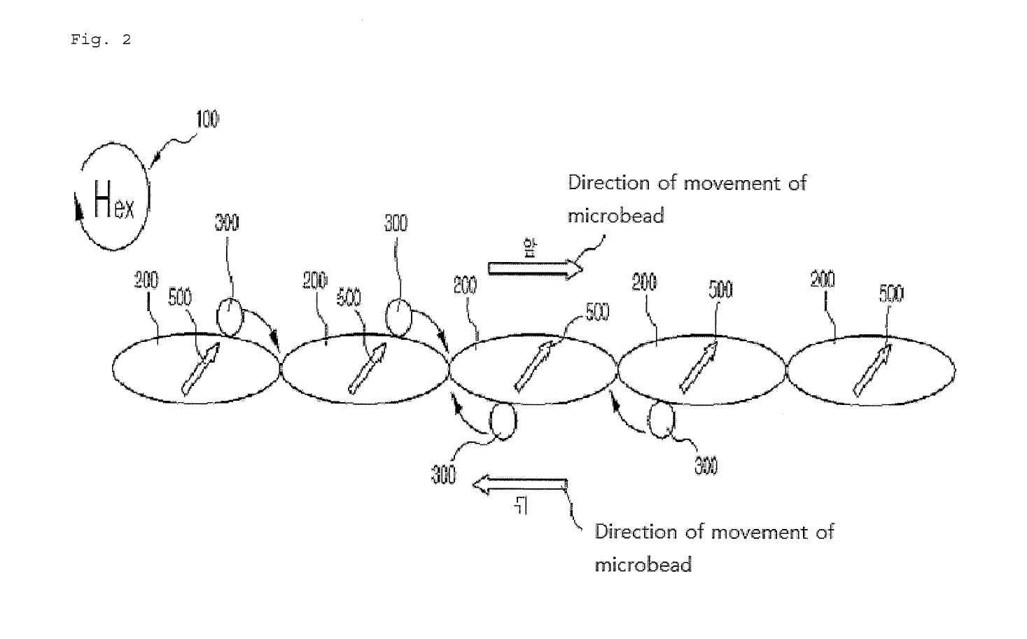

As illustrated in FIGS. 2 to 4, the micro magnetic device 200 in accordance with an embodiment of the present invention can be arranged in series so as to attract the microbead 300 to a sensing site in which probe molecules are immobilized within a microfluidic chip.

As illustrate in FIG. 1, the direction of the magnetization of the micro magnetic device 200 changes as the external magnetic field 100 rotates. Difference between the internal magnetic fields 400 attracts the microbead 300 to a pole of the micro magnetic device 200 where stronger internal magnetic field 400 is present. That is, the attraction force between the micro magnetic device 200 and the micro bead 300 generates various internal magnetic fields of different directions according to an aspect ratio of the micro magnetic device 200.

In accordance with an embodiment of the present invention, the external magnetic field of 50 to 100 oersted is sufficient to saturate the micro magnetic device 200 and the external magnetic field of 200 oersted or greater does not increase the degree of change of the internal magnetic field 400 any more.

As illustrate in FIG. 1, the micro magnetic device 200 magnetized by the external magnetic field generates a partial internal magnetic field 400 by the geometrical structure and soft magnetism of the micro magnetic device 200. In this case, by the difference between magnetic forces of the internal magnetic fields 400, the microbead 300 moves to the pole of the micro magnetic device 200 where the internal magnetic field 400 is strongest.

That is the micro magnetic device 200 magnetized by the external magnetic field 100 can generate the partial internal magnetic field 400 by its geometrical structure and soft magnetism, and move the microbead 300 by the rotating or oscillating external magnetic field 100.

FIG. 2 is a view illustrating a structure that micro magnetic devices of an elliptic disc shape for straight linear movement of a microbead are arranged in series.

As illustrate in FIG. 2, when the external magnetic field 100 rotates, a partial difference between the forces of the internal magnetic fields 400 dominates the movement of the microbead 300. That is, the microbead 300 moves along the direction of the magnetization of each micro magnetic device 200, from one micro magnetic device 200 to adjacent another micro magnetic device 200.

As illustrated in FIG. 2, when the external magnetic field 100 rotates in a clockwise direction or a counterclockwise direction and the micro magnetic device 200 has an elliptic disc shape and is within the fluidic channel, it is possible to translocate the microbead 300 to a specific position of the fluidic channel.

In accordance with an embodiment of the present invention, as illustrate in FIG. 2, when the external magnetic field 100 rotates in a clockwise direction and the microbead 300 is placed above the micro magnetic device 200, the microbead 300 moves forward. Also, when the external magnetic field 100 rotates in a clockwise direction and the microbead 300 is placed below the micro magnetic device 200, the microbead 300 moves backward.

The direction of movement of the microbead 300 in the path as illustrate in FIG. 2 is determined by the geometrical structure of the micro magnetic device 200 and the position of the microbead 300.

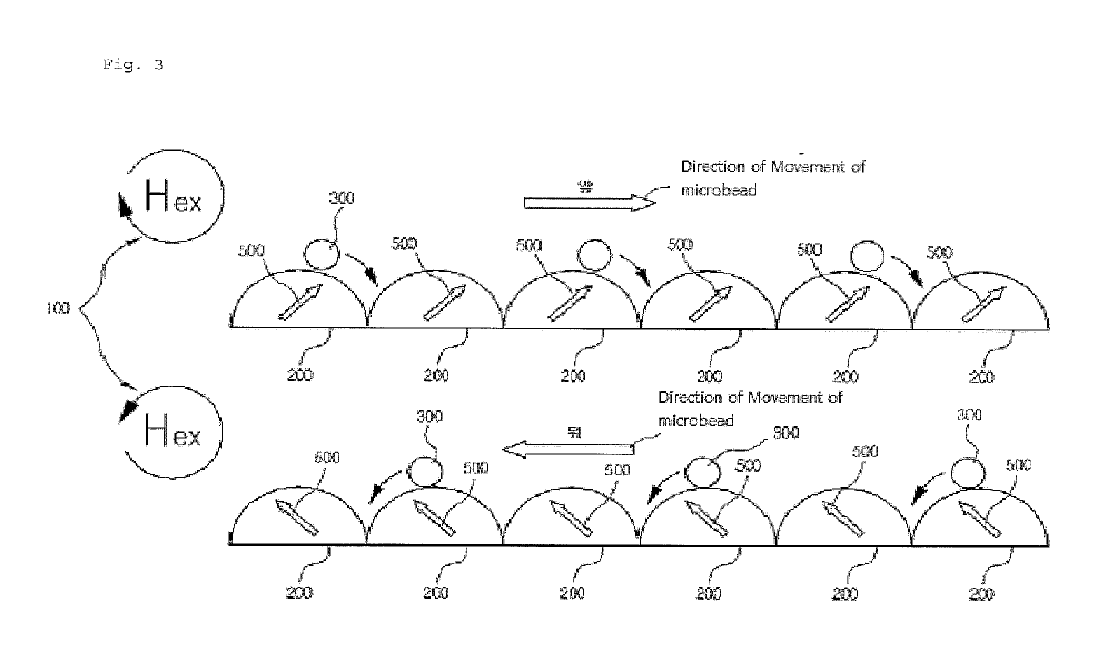

FIG. 3 is a view illustrating a structure that micro magnetic devices of a semi-elliptic disc shape for forward and backward directional movement of a microbead are arranged in series.

As illustrate in FIG. 2, it is possible to move the microbead 300 forward or backward according to the rotational direction of the external magnetic field 100. When compared to the movement of the microbead 300 illustrate in FIG. 2, the movement of the microbead 300 is determined only by the rotational direction of the external magnetic field 100.

As illustrated in FIG. 3, when the external magnetic field 100 rotates in a clockwise direction and the micro magnetic device 200 has a semi-elliptic disc shape, the microbead 300 moves forward. Also, when the external magnetic field 100 rotates in a counterclockwise direction and the micro magnetic device 200 has a semi-elliptic disc shape, the microbead 300 moves backward.

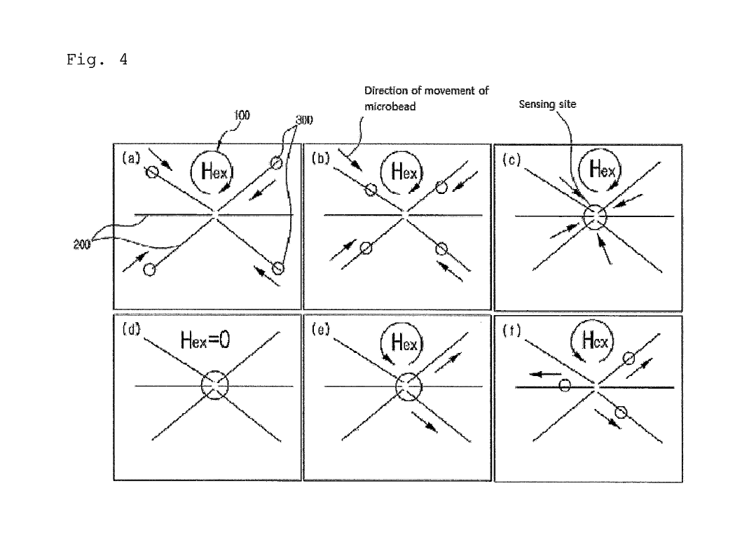

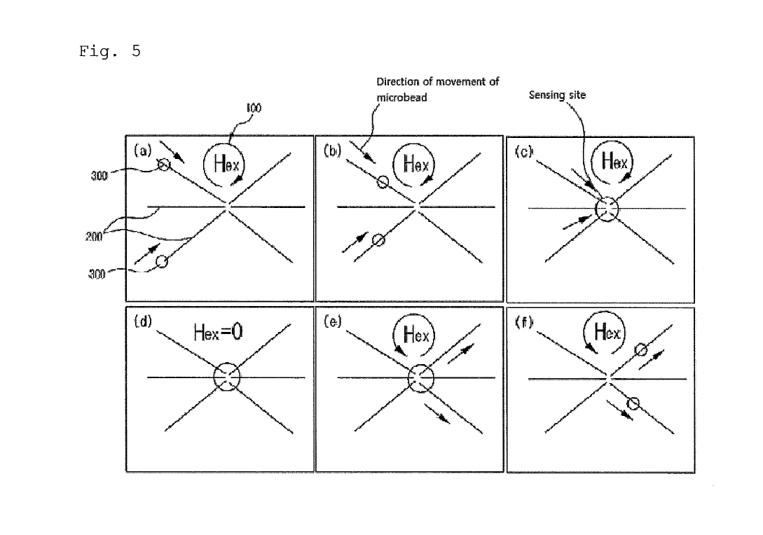

FIG. 4 is a view illustrating a structure that micro magnetic devices of a semi-elliptic disc shape for gathering or spreading microbeads according to a rotational direction of an external magnetic field are arranged in series in a diagonal direction.

As illustrated in FIG. 4, when the external magnetic field 100 rotates in a clockwise direction and the micro magnetic devices 200 are arranged in a diagonal direction, the microbeads 300 are concentrated in the portion where the diagonal lines are gathered. Also, when the external magnetic field 100 rotates in a counterclockwise direction and the micro magnetic devices 200 are arranged in a diagonal direction, the microbeads 300 are spread from the portion where the diagonal lines are gathered.

In this case, it is preferred that the portion where the diagonal lines are gathered is realized as a sensing site in which probe molecules are immobilized within a microfluidic chip. In accordance with an embodiment of the present invention, it is possible to induce the change of the path of the microbead only by formation of minute magnetic force. Also, in accordance with an embodiment of the present invention, it is possible to realize a lab-on-a-chip by carrying out a series of bioassays within a microfluidic chip.

While the present invention has been described with respect to the specific embodiments, it will be apparent to those skilled in the art that various changes and modifications may be made without departing from the spirit and scope of the invention as defined in the following claims.

1. A micro magnetic device for biomolecule translocation, comprising:
a magnetic force generator for controlling an external magnetic field to magnetize a micro magnetic device and a microbead;
with the micro magnetic device generating an internal magnetic field when magnetized by the external magnetic field, and controlling movement of the microbead according to a direction of magnetization; and
with the microbead immobilizing a biomolecule on a surface thereof and of which movement is controlled by the internal magnetic field generated as the micro magnetic device is magnetized.

2. The micro magnetic device of claim 1, wherein the micro magnetic device is formed by patterning a soft magnetic thin film made of one of NiFe, Fe, Ni and Co.

3. The micro magnetic device of claim 1, wherein the micro magnetic device has one shape of an elliptic disc and a semi-elliptic disc.

4. The micro magnetic device of claim 1, wherein the micro magnetic device is arranged in series so as to attract the microbead to a sensing site in which probe molecules are immobilized within a microfluidic chip.

5. The micro magnetic device of claim 1, wherein the micro magnetic device has a saturation magnetization of 1 tesla and a length of 10 μm or smaller.

6. The micro magnetic device of claim 1, wherein a degree of change of the internal magnetic field is within a range of 10⁴ T/m.

7. The micro magnetic device of claim 1, wherein the micro magnetic device magnetized by the external magnetic field generates a partial internal magnetic field by its geometrical structure and soft magnetism, and moves the microbead to a pole of the micro magnetic device where the internal magnetic field is strongest by a difference between magnetic forces of the internal magnetic fields.

8. The micro magnetic device of claim 1, wherein the micro magnetic device magnetized by the external magnetic field generates a partial internal magnetic field by its geometrical structure and soft magnetism, and moves the microbead by the rotating or oscillating external magnetic field.

9. The micro magnetic device of claim 1, wherein the microbead is translocated to a specific position of the fluidic channel when the external magnetic field rotates in a clockwise direction or a counterclockwise direction and the micro magnetic device has an elliptic disc shape and is within the fluidic channel.

10. The micro magnetic device of claim 1, wherein the microbead is translocated forward when the external magnetic field rotates in a clockwise direction and the micro magnetic device has a semi-elliptic disc shape, and the microbead is translocated backward when the external magnetic field rotates in a counterclockwise direction and the micro magnetic device has a semi-elliptic disc shape.

11. The micro magnetic device of claim 1, wherein when the external magnetic field rotates in a clockwise direction and the micro magnetic devices are arranged in a diagonal direction, the microbeads are concentrated in a portion where the diagonal lines are gathered, and when the external magnetic field rotates in a counterclockwise direction and the micro magnetic devices are arranged in a diagonal direction, the microbeads are spread from the portion where the diagonal lines are gathered.

12. The micro magnetic device of claim 11, wherein the portion where the diagonal lines are gathered is a sensing site in which probe molecules are immobilized within a microfluidic chip.

13. (canceled)

14. (canceled)
